(19) United States
(12) Patent Application Publication
(10) Pub. No.: US 2019/0371327 A1
(43) Pub. Date: Dec. 5, 2019

(54) SYSTEMS AND METHODS FOR OPERATING AN OUTPUT DEVICE

(71) Applicant: Disruptel, Inc., St. Louis, MO (US)

(72) Inventors: Alexander Clifford Hunt Quinn, Red Bud, IL (US); John F. Lowrey, Ballwin, MO (US)

(21) Appl. No.: 16/431,415

(22) Filed: Jun. 4, 2019

Related U.S. Application Data
(60) Provisional application No. 62/680,372, filed on Jun. 4, 2018.
(60) Provisional application No. 62/692,645, filed on Jun. 29, 2018.
(60) Provisional application No. 62/712,767, filed on Jul. 31, 2018.
(60) Provisional application No. 62/811,323, filed on Feb. 27, 2019.

(51) Int. Cl. G10L 15/22; H04R 1/40; H04R 3/00; G06K 9/00; G06F 3/01; G06F 17/27; G10L 15/16; G10L 15/06

(52) U.S. Cl. CPC G10L 15/22; H04R 1/406; H04R 3/005; G06K 9/00335; G06F 3/017; G10L 2015/088; G10L 15/16; G10L 15/063; G06K 9/00711; G06K 9/00288; G10L 2015/223; G06F 17/274

(57) ABSTRACT

Systems and methods for operation and control of a smart device, generally a video output device. An aspect is a gesture-based control system that identifies the operative user, regardless of how many potential users are present in the room, and regardless of where each potential user is disposed in the room. Another aspect is controlling and interfacing with a user output device using various types of queries and context cues, and responding to queries by resolving ambiguities in the query. These aspects may be used independently or in combination.

### CROSS-REFERENCE TO RELATED APPLICATIONS

This application claims benefit of U.S. Prov. Pat. App. Ser. No. 62/680,372, filed Jun. 4, 2018, and U.S. Prov. Pat. App. Ser. No. 62/692,645, filed Jun. 29, 2018, and U.S. Prov. Pat. App. Ser. No. 62/712,767, filed Jul. 31, 2018, and U.S. Prov. Pat. App. Ser. No. 62/811,323, filed Feb. 27, 2019. The entire disclosure of all of these documents is incorporated herein by reference.

### BACKGROUND OF THE INVENTION

### Field of the Invention

This disclosure is related to the field of human interface systems, and more particularly to systems and methods for controlling and interfacing with a user output device using various types of queries, and for responding to ambiguous queries by using context cues.

### Description of the Related Art

The human interface of televisions and other user output devices has become more similar to that of conventional computers, such as smart phones, tablet PCs, and laptops. To accommodate this shift, manufacturers have attempted to create gesture-based controls; that is, the ability to control the display using one's hands or other body-based motion. These attempts have failed because it is difficult to manage room-wide access to the control of a single device while distinguishing among multiple simultaneous users with sufficient accuracy for commercial use.

Another common problem is that shared VUI systems respond to commands from multiple users when control is desired by one user at a time. For example, current voice-response systems generally do not discriminate among different voices in the room. If, for example, a first person says to a VUI, “Play rock music,” the system will transcribe the spoken text, parse the request, and respond by playing the type of requested music. If a second person says, “Stop,” the system will dutifully repeat this process, and stop. The VUI does not determine whether the second voice is the same as the first voice, and does not attempt to filter or sort among multiple users issuing commands. This can result in conflicting instructions and undesired behavior from the VUI.

Additionally, the proliferation of voice user interfaces (VUIs) and voice command devices (VCDs) has created a need in the market for smarter context-specific query resolution. In the English vernacular, the use of pronouns is commonplace and listeners are expected to decode the pronoun based on available contextual information. For example, if two people are in a quiet location and a loud noise is heard, one may exclaim, “What was that?” It is clear to the other person that the word “that” refers to the loud noise. Similarly, when two people are watching a football game, one may say, “Who is the quarterback?” It is clear to the other that the speaker is referring to the quarterback for the team on offense.

However, VUIs, such as digital assistants, lack this context-based information. When a computer fails to understand the context, the user can become annoyed or frustrated. Moreover, such failures underline the limitations of artificial intelligence, reducing the user's confidence in the technical capabilities of the computer in question. Thus, humans interacting with them must engage in overly formalistic, precise, and stilted verbal instructions that feel unnatural.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a non-transitory computer-readable medium having computer-readable program instructions embodied thereon, said instructions comprising: a request acquisition module receiving an audibly spoken question including a noun-phrase and a video stream, said request acquisition module converting said audibly spoken question to text and capturing a image data of a still frame of said video stream associated with a point in time of said video stream when said audibly spoken question is received; a noun-phrase extraction module receiving said text and extracting therefrom said noun-phrase; a target selection module identifying target data in said image data, said target data corresponding to said extracted noun-phrase; a subject identification module generating a textual description of the identity of a target represented in said target data; and a response module generating a script comprising said noun-phrase and said textual description of said identity.

In an embodiment of the medium, said audibly spoken question is converted to text by a speech recognition module.

In another embodiment of the medium, said request acquisition module further includes program instructions for acquiring metadata about said video stream.

In another embodiment of the medium, said target selection module identifies said target data using a machine learning system.

In another embodiment of the medium, said machine learning system comprises a neutral network.

In another embodiment of the medium, said subject identification module generates said textual representation using a machine learning system.

In another embodiment of the medium, said machine learning system comprises a plurality of neural networks, each neural network in said plurality being trained on a target category.

In another embodiment of the medium, the instructions further comprise: a target categorization module assigning a category to said target data; and said subject identification module generating said textual description using a selected neural network from said plurality of neural network, said selected neural network being determined based on said assigned category.

In another embodiment of the medium, said medium is included in a display device.

In another embodiment of the medium, said display device is a smart television.

In another embodiment of the medium, said medium is included in a mobile device.

In another embodiment of the medium, said video stream is received via a telecommunications network.

In another embodiment of the medium, said response module causes to be vocalized a response to said audibly spoken question, said vocalized response based at least in part on said script.

In another embodiment of the medium, said vocalization is performed using a voice user interface.

In another embodiment of the medium, said voice user interface comprises a digital assistant.

In another embodiment of the medium, said target data represents a subject selected from the group consisting of: a human; an animal; a vehicle; an article of clothing; a venue; a geographic feature; a structure; a building; and, a consumer product.

Also described herein, among other things, is a computerized method for answering an ambiguous user query comprising: receiving a video stream and displaying said video stream; receiving an audibly spoken question at a first time during said display of said video stream; converting said audibly spoken question to text; capturing image data of said video stream at said first time; extracting a noun-phrase from said converted text; identifying in said image data target data corresponding to said noun-phrase; generating a textual description of said target data; generating a script comprising said noun-phrase and said textual description; and

vocalizing said script.

In an embodiment of the method, the method further comprises: assigning a category to said target data; and in said generating a textual description, generating said textual description using a neural network trained using image data corresponding to said category.

Also described herein, among other things, is a method for gesture-based control of a display device comprising: providing a display device comprising a computer vision system and a microphone array; said microphone array locating an origin of a spoken wake-word; said computer vision system identifying a first human at said origin; forming a user profile for said identified first human, said user profile including facial recognition data for said identified first human; said computer vision system recognizing at least one control gesture performed by said identified first human, said at least one control gesture corresponding to a ruleset for operating said display device; and operating said display device in accordance with said recognized at least one control gesture.

In an embodiment of the method, the method further comprises: storing said user profile in a computer-readable storage medium; repeating said locating, said identifying, said font ling, said recognizing, and said operating steps for a second human; after said microphone array locating a second origin of a spoken wake-word and said computer vision system identifying said first human at said second origin, retrieving said user profile for said first human.

### BRIEF DESCRIPTION OF THE DRAWINGS

FIG. 1 depicts an embodiment of a system for gesture-based control of a display according to the present disclosure.

FIG. 2 depicts an embodiment of a method for gesture-based control of a display according to the present disclosure.

FIG. 3 depicts an embodiment of a method for disambiguation of a spoken inquiry according to the present disclosure.

FIG. 4 depicts an embodiment of another method for disambiguation of a spoken inquiry according to the present disclosure.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein, among other things, is a highly accurate gesture-based control system that consistently achieves high accuracy identification of the operative user, regardless of how many potential users are present in the room, and regardless of where each potential user is disposed in the room. Also described herein, among other things, are systems and methods for controlling and interfacing with a user output device using various types of queries and cues, as well as for responding to queries by resolving ambiguities in the query using context cues. These aspects may be used independently or in combination in any given embodiment.

Throughout this disclosure, the term “computer” describes hardware that generally implements functionality provided by digital computing technology, particularly computing functionality associated with microprocessors. The term “computer” is not necessarily limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices that are not conventionally thought of as “computers” may, in some instances, exhibit the characteristics of a “computer” and could be considered a “computer” within the scope of this definition. For example, in certain contexts, where such a device is performing the functions of a “computer” as described herein, the term “computer” could include such devices to that extent. Devices of this type include, but are not necessarily limited to: network hardware, print servers, file servers, NAS and SAN, load balancers, and other hardware capable of, or adapted or configured for, interacting with the systems and methods described herein in the manner of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer-readable media having computer-readable program code embodied thereon.

Any combination of one or more computer-readable media may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Program code embodied on a computer-readable medium may be transmitted using any appropriate medium, including but not limited to wireless, wireline, optical fiber cable, RF, etc., or any suitable combination of the foregoing.

Throughout this disclosure, the term “network” generally refers to a voice, data, or other telecommunications network over which computers communicate with each other.

Throughout this disclosure, the temi “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the term “real time” refers to steps, processes, or other activity occurring within operational deadlines to present to a human user the perception or impression that the activity in question is effectively occurring contemporaneously with a reference event. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of about one second or less of real time, with milliseconds or microseconds being preferable. However, those of ordinary skill in the art also understand that, under other operational contexts, a system operating in “real time” may exhibit delays longer than one second, particularly where network operations are involved.

As used throughout this disclosure, “mobile device” means a portable computer system in the nature of a smart phone, tablet PC, e-reader, fitness device (e.g., a Fitbit™ or Jawbone™) or any other mobile computer, whether of general or specific purpose functionality. Generally speaking, a mobile device is network-enabled and communicating with a server system providing services over a network. A mobile device is essentially a mobile computer usually associated more strongly with a user than with a particular location, and is also commonly carried on a user's person, and usually is in near-constant real-time communication with a network.

As used throughout this disclosure, the terms “request,” “question,” “query,” “inquiry,” and the like generally mean a question, command, or prompt provided by a user to which the user expects to receive a response containing an answer. Generally, the query is provided audibly (e.g., spoken). The response may also be provided audibly, but other forms of response may be provided in addition to, and/or in lieu of, an auditory response, such as by displaying information on a display device (which may be the same or different as the device having the VUI).

As used throughout this disclosure, the terms “decode”, “disambiguate”, and “resolve” generally mean the processes described herein for determining a specific object or subject of an inquiry referenced by an ambiguous part of speech or phrases in the inquiry.

As used throughout this disclosure, the term “video stream” generally means visual data provided to and used by a display device to cause light to be emitted from the display in a fashion designed to present certain visual content, such as a television program, sporting event, video game, or other computer-generated image. Modern video streams are typically digital and presented in a standard format. Some or all of a video stream may be used (both in terms of amount of the screen geometry analyzed and temporal duration over which the video stream is analyzed).

As used throughout this disclosure, “audio stream” has a similar meaning to video stream but refers instead to audio content, which may be presented together with or independently from the video stream. Examples include sound recordings played in synchronization with the video stream (e.g., film, television, or video game audio), or secondary or supporting audio content, such as accessible assistants and screen readers. Audio streams and video streams are often provided together and can include content related to each other. For example, closed captions and subtitles are visual elements that provide information about audio content.

As used throughout this disclosure, “metadata” generally means data about data, and primarily refers to data about video streams and/or audio streams. Examples include, but are not limited to, metadata packaged with a video or audio streams, or otherwise available to describe or provide context for a video or audio stream, such as title, runtime, publisher, author, actors, producers, age ratings, critical ratings, description, availability of accessible features such as (but not limited to) closed captioning, audio assistants, and/or subtitles and the languages thereof.

As used throughout this disclosure, “VUI” generally means “voice user interface” and refers to computer software and/or hardware systems and modules that enable spoken human interaction with computers, generally using speech recognition to understand spoken human speech, and generally text-to-speech to audible speak responses. Such systems may be implemented as standalone software packages but are more commonly implemented in a client-server architecture, where a user device functions as the client device receiving speech from the end user and playing back responses, but some or all other functions (e.g., speech recognition, transcription, search, response formation) are carried out remotely via a server system. Examples of current commercial deployments of such technologies include Siri™, Cortana™, and Alexa™.

As used throughout this disclosure, “VCD” generally means “voice command device” and refers to a device controlled using a VUI. Examples include smart phones, smart displays, home automation systems, and digital assistant appliances.

In a first aspect of the systems and methods described herein, a combination of audio and visual cues are used to facilitate the shifting of the “attention” of a computer system from one user to another. This may be done, for example, using an attention cue. A typical use case is a shared computer system that is desired to respond to commands from one user at a time among several. Current VUI systems generally do not discriminate among different voices in the room. If, for example, a first person says to a VUI, “Play rock music,” the system will transcribe the spoken text, parse the request, and respond. If a second person says, “Stop,” the system will dutifully repeat this process, and stop. The VUI does not determine whether the second voice is the same as the first voice, and does not attempt to filter or sort among multiple users issuing commands.

Using the systems and methods described herein, a single user is identified as the “active” user or “command” user from among a plurality of potential or “candidate” users of the system. By default, there may be an active or command user determined or selected by the system, but in an alternative embodiment, a VUI system may be configured or set up with a default setting (e.g., the first person who speaks to it is the command user). In any event, and regardless of the default or current command user setting, a second user (e.g., a candidate user) can attempt to become the active user by issuing an attention cue to the system.

This cue may be in the nature of a “wake-word.” The “wake-word” is generally a word or short phrase that the VUI is programmed to interpret as an attempt to shift the active user to whomever spoke the wake-word. The wake-word is generally a predetermined word or short phrase, and ideally one that is uncommon enough in everyday speech that it is unlikely to be spoken and inadvertently trigger the VUI to attempt an active user change. For example, a made-up, nonsense word may be used that has no other meaning in the language of the system. The wake-word may be preprogrammed or may be configured or changed by a user or system administrator via a settings or configuration interface.

When the wake-word is detected as having been spoken, the system will attempt to identify the speaker, and, possibly attempt to shift the active user. This may be done using a number of different techniques, alone or in combination. In an embodiment, upon detecting the wake-word, the VUI may use acoustic source localization to determine, estimate, or approximate the physical location of the candidate user who issued the wake-word. Next, visual recognition may be used (e.g., via a camera or other optical sensor) to visually identify the user closest to the detected source location of the wake-word. This may be done using, for example, computer vision software and/or body motion of the candidate user in question. Once the user is visually identified, a profile, or data, for that user may be created, stored, or retrieved to determine if the user has previously used the system. If so, previously stored settings, preferences, configuration data, or other information specific to the detected user may be retrieved or otherwise used to improve or customize the user experience.

In an embodiment, previously stored permissions or command settings may be retrieved or used to determine the scope of commands the system will accept from the active user, or potentially to refuse access to the user entirely and disregard the wake-word. These techniques may be done, for example, in the case where the user lacks sufficient permission to command the system at all (e.g., a small child), or where the user has been blocked for any reason (e.g., prior misuse). In an embodiment, the system may automatically block users whose usage patterns are indicative of abusive use or misuse in accordance to the acceptable use policies of the system administrator (e.g., repeated interruptions of others).

If the user is determined as being able to become the active user (again, under the particular rules and policies programmed or configured into the particular embodiment), the identified user then becomes the “active” or “command” user, and the prior active user (if any) is considered part of the pool of a non-active, candidate users. The system may then conduct continued visual monitoring of the active user. For example, if the user moves to a new location, the “attention” of the visual monitoring can follow. Also, the active user's motion or gestures may be monitored and translated into instructions or input, generally in accordance with a preprogrammed ruleset. For example, a set of predefined gesture-based controls for use of the system may be implemented, or the VUI may be programmed to detect the gestures of a visual-manual language, such as American Sign Language. The system can also, or alternatively, receive further spoken commands or queries from the user, and process those spoken commands or queries in accordance with the VUI's capabilities. Those capabilities may, in an embodiment, include other aspects of the systems and methods described herein, such as, without limitation, the disambiguation functions.

Once the active user is finished, he or she may “release” control of the system, such as by repeating the wake-word or speaking a different key word, or issuing a gesture that indicates the user's desire to release control. Additionally, or alternatively, the system may be programmed to simply transfer control to the next speaker of the wake-word, whether or not the active user has release control. The decision whether to transfer may also depend on permissions settings. For example, if the active user is determined as “out-ranking” a candidate user attempting to gain control of the system according to the permissions settings of the system, control may remain with the current user unless the active user indicates a desire to release control (again, by gesture, wake-word, etc.). However, if the candidate user out-ranks the active user, control may be transferred.

Thus, the system may be implemented in a range of embodiments having various degrees of security and command and control structure. In a very simple embodiment, the system is effectively a permissionless free-for-all where any user may gain control at any time. In a more advanced embodiment, a complex set of tiered permissions, roles, and user profiles may be used to tightly regulate access to and control of the system at a granular level.

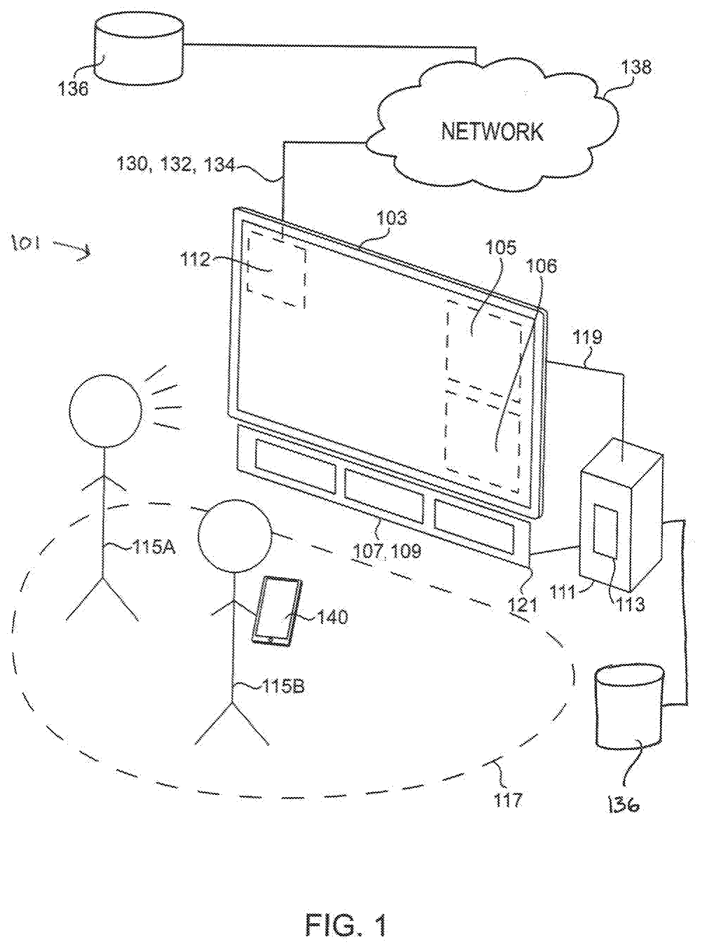

FIG. 1 depicts an illustrative, non-limiting embodiment (101) of such a system. In the depicted embodiment (101), a user output device (103), including a VUI (106), is controlled via a gesture-based controlled system (101). The depicted device (103) is a television, but any user output device may be operated using the systems and methods described herein. The depicted device (103) includes an operating system (105) associated therewith and operable to control the functions of the device (103). As will be clear to a person of ordinary skill in the art, a typical device (103) has the operating system (105) embedded therein.

In association with the device (103), a microphone array (107) and a computer vision system (109) are deployed in a configuration configured to provide the microphone array (107) and computer vision system (109) access to a field (117). The field (117) is the physical space in which users (115A) and (115B) may be positioned when attempting to access or control the device (103) using the systems and methods described herein. Typically, the field (117) is a room or sub-portion of a room, in which users would reasonably be expected to attempt to operate the device (103).

In the depicted embodiment of FIG. 1, a computer (111) is operatively coupled (119) to the operating system (105) and operatively coupled (121) to the microphone array (107) and computer vision system (109). The depicted computer (111) comprises a non-volatile storage medium having software instructions (113) thereon, which comprise program logic for implementing the steps and functions described herein. As will be clear to a person of ordinary skill in the art, the computer (111) may be a physically distinct computer as shown in FIG. 1, or may be part of, incorporated into, or the same computer as a computer within the device (103), such as the computer having the operating system (105).

It is expected that legacy devices may be upgraded to use the systems and methods described herein controlled by an external computer (111) as depicted in FIG. 1, but, preferably, these methods are implemented in software within the device (103). Similarly, the microphone array (107) and computer vision system (109) are depicted in FIG. 1 as separate elements, but may be, each individually or both together, integrated into or otherwise made part of the computer (111), the device (103), or both. The coupling (119) and (121) of the computer to the operating system (105) and the microphone array (107) and computer vision system (109), respectively, may be done through any means known in the art. This may include wired or wireless connections.

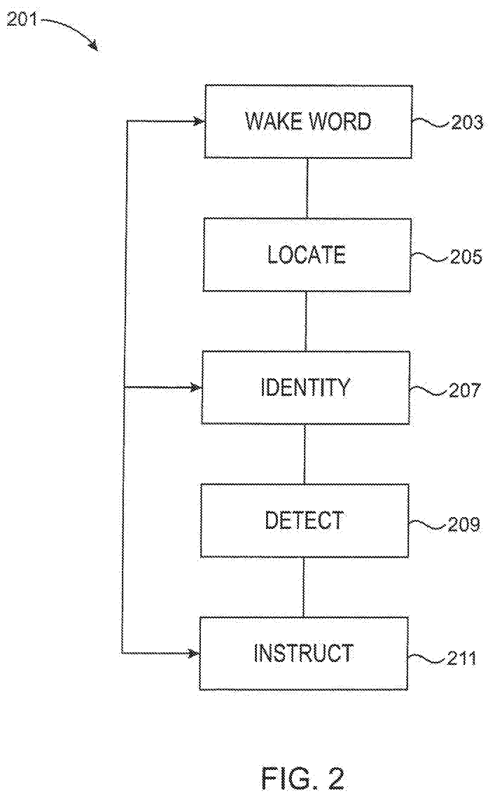

FIG. 2 depicts an embodiment of a method that may be implemented using the system depicted in FIG. 1. In the depicted embodiment of FIG. 2, a potential user (115A) or (115B) verbally articulates (203) a wake-word. This word may be any verbal articulation that may be distinctly determined and confirmed via the computer software. For example, the word may be “Waldo.” The microphone array (107) is in a listening configuration in which it actively monitors detectable noise and analyzes the data to determine when the wake-word is spoken. Once the wake-word is spoken (203), the position of the speaker in the field (117) is determined (205). This may be done using any method known in the art, including acoustic source localization. By way of example and not limitation, the microphone array (107) may comprise a plurality of microphones configured such that the differential in timing, at which mechanical signals such as sound waves are detected as arriving at the microphone, may be used to triangulate a point of origin of the wake-word.

Next, the computer vision system (109) may identify (207) the individual speaker of the wake-word from step (203). This is done by coordinating with the microphone array (107) to acquire the location in the field (117) of the speaker, and providing that data to the computer vision system (109). The computer vision system (109) can then determine a location in the field (117) corresponding to the detected point of origin of the detected wake-word. This allows the computer vision system (109) to select one individual from possibly many visually detectable humans in the field (117) as being the origin of the wake-word. That individual's features may then be identified (207) and associated as the active user. The computer vision system (109) can then monitor (209) that user to detect gestures or other motions that correspond with an instruction. This instruction may then be provided (211) to the operating system (105) to control the display (103). This may then be repeated until a different user says the wake-word (203). At that point, the locate (205) and identify (207) steps are repeated with the newly identified active user.

The detected gestures may be any gestures which the software (103) is detected to or is programmed to detect. Typically, this comprises gestures carried out with the hands, but may include gestures carried out with other body parts, such as head shakes, movement of the eyes, and so forth. This technology may have particularly important uses for disabled individuals who may lack full motion or use of the hands or arms.

A second aspect of the system and methods described herein is the use of context cues to disambiguate queries. This aspect has a number of applications, and the primary use case that will be described herein, for non-limiting, illustrative purposes, is the use of VUI (106) in conjunction with a specific type of VCD, namely, an audiovisual output device such as a smart television (103) or smart display (103). Although the use of a smart television (103) is described herein, it will be understood that this description is also applicable to other VCDs, particularly those having a computer (111), a network communications device (112), which receive audio streams (132), video streams (130), and/or metadata (134) about the audio (132) and video streams (130) or other content received. In some embodiments, network (138) connectivity may be used to access third party services (136) for additional information. The described techniques may be used in a single stand-alone device or the functions spread among a plurality of devices, local or remote, in accordance with the particular design and engineering requirements of a given embodiment.

Generally, a VUI (106), whether included in the VCD (103) or otherwise operatively coupled to it, answers questions spoken by a user, where the question usually relates to video or audio stream content at the time the question is asked. To the extent that the question contains ambiguities, the VUI (106) attempts to disambiguate or decode the ambiguities in the query with reference to context data. The decoded query can then either be used to search directly for an answer, or provided to a third party VUI to find the answer, which is then relayed to the user.

The context data generally includes the audio (132) and video streams (130), alone or in combination with other data sources, such as metadata (134) and databases (136) and data services (136), which can be examined to fill in the “blanks” of the user query containing an ambiguous question. Generally, the decoding is performed automatically, programmatically, and in real-time.

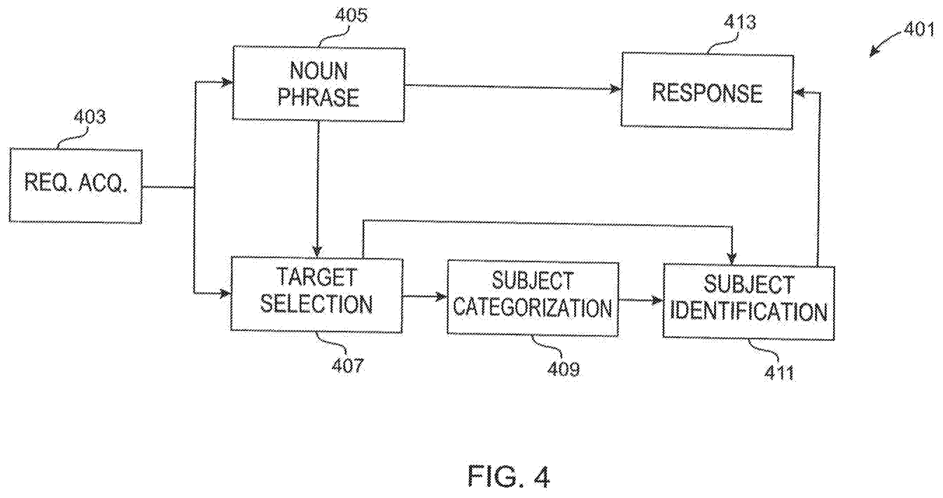

FIG. 4 depicts an embodiment of the method (401), and FIG. 1 depicts an embodiment of a system (101) that can be used to perform the method (401). It should be noted that the system depicted in FIG. 1 also is suitable for performing the method depicted in FIG. 2, and thus may contain additional elements not necessarily used for performing the method (401) of FIG. 4. It should also be noted that the steps depicted in FIG. 4 are exemplary. Not all depicted steps are used in every embodiment, and a depicted step may in turn comprise substeps.

At a high level of abstraction, the decoding method (401) generally comprises request acquisition (403), noun-phrase extraction (405), target selection (407), subject identification (411), and response formation (413). In an embodiment, subject categorization (409) may also be included. These and other aspects are described in more detail herein. It will be understood that these aspects will be generally described herein as distinct modules with particular inputs and outputs, but it will be clear to a person of ordinary skill in the art that, depending on the nature of a particular embodiment and query, there may be overlap in the implementation of these functions, and similar techniques can be used to implement them, such as image recognition and deep learning. Thus, one or more elements may be combined, or the functionality described herein may be distributed differently than shown in FIG. 4 while remaining within the scope of this disclosure. Also, a number of exemplary, non-limiting examples are provided to illustrate certain particular applications of the systems and methods in various embodiments.

Steps (403), (405), and (407) can be thought of as a process for programmatically identifying the subject or target (303) of the query, including whether that target (303) is represented or depicted in available data (often, but not always, the video stream (130)). It should be understood that the specific identity of the target (303) is generally not determined in this stage; rather, the collection of data representing or depicting the target (303) is determined. By way of non-limiting example, such targets (303) may be a scene, setting, action, a person, actor, object, building, venue, product, or location about which the user has spoken a query. The specific identity of the target is determined by another module/step (411), such by searching local databases or accessing third party services, as described elsewhere herein.

Request acquisition (403) generally comprises receiving and/or detell lining a query and a context for the query. Typically, the query is received audibly as a spoken request from a user and converted or transcribed to text. Voice recognition and transcription techniques are known and suitable for use. Other context for the request may also be acquired at this time. This context generally includes capturing a screenshot or “frame” of the video stream (130) associated with a device (103) at about the time the request was received. In the simplest case, this may be a single frame, but it is specifically contemplated that additional video stream (130) context may be acquired. For example, several seconds of the video stream (130) from immediately before the query was received may also be captured. For purposes of this description, “video stream (130)” is used generically to mean the image data context acquired, with the understanding that it may be a single frame or a set or series of frames comprising a clip or longer segment of the video stream (130).

Other context data may be captured. For example, if metadata (134) is available with additional information about the particular audiovisual work represented in the video stream (130), this information may also be captured. Such metadata (134) is generally available from the video stream (130) source (e.g., a satellite television or cable company, streaming service provider, physical media). It could also be determined programmatically, if not otherwise available, such as using the video stream (130) to conduct a reverse-image lookup in a database, which could be a local database (136) or third party database (136).

Other context data may be captured, such as assigning a category associated with the content (e.g., news, sports, movie, etc.), determining a title associated with the video stream (130) (show title, movie title, etc.), determining information about the video stream (130) (e.g., cast, crew, characters, team name), or any other data.

In an embodiment, image recognition may be used to identify in the video stream (130) objects (e.g., a football and goal posts), and categorize the context (e.g., a sports event and, more specifically, a football game). Likewise, many types of content have common or obligatory elements that can be detected in the video stream (130) to identify, for example, a game show, a news broadcast, a sporting event, an awards show, and so forth.

In an embodiment, the VUI (106) may consult local or third party databases (136) or data services (136) to determine context, or to supplement the context data with additional information. Other available data may also be used, alone or in combination, such as date and time information, geographic information, and the like. For example, if metadata (134) is able to identify that the context is a playoff hockey game, but the teams are not identified in the metadata (134), the current date and time can be used to reference a schedule database (136) and supplement the context with the identity of the teams, where the game is being played, what the series win/loss record is, player rosters, coaches, broadcasters, officials, start and end time, and so forth.

Thus, the input to the request acquisition (403) is generally the current video stream (130) and audio stream (132) and the spoken request, and the output is a textual transcription of the spoken request, image (and/or audio) data of the video stream (130) at the time of the request, and/or context data about the audiovisual work in question. This data is collectively referred to as “request data.”

In the depicted embodiment of FIG. 4, request data is used to select or find the subject or target of the query in the video stream (130), and, more specifically, the captured image data. This is done using a combination of noun-phrase extraction (405) and target selection (407). The input to the depicted noun-phrase extraction (405) module is generally the request data, and the output is the noun-phrase as text. As shown in FIG. 4, this could be provided to a target selection (407) module.

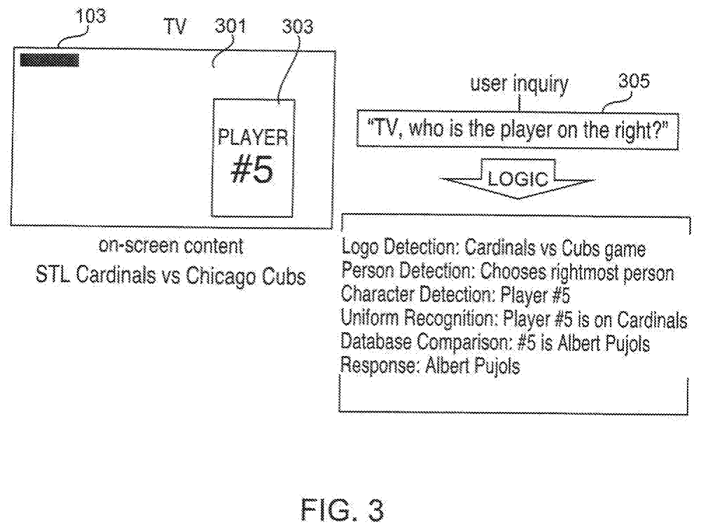

The input to the depicted target selection (407) module is also some or all of the request data and may include the extracted noun-phrase, and the output is generally some or all of the request data and also the data selected by the target selection (407) module. This data is generally a subset of the video stream (130); that is, a “cropped” or “segmented” subset of the video stream (130) representative of the sub-portion of the video stream (130) corresponding to the noun-phrase. Referring to FIG. 3, the request data includes the current frame (301) of the video stream (130), and the target selection (407) module identifies the subset (303) of that frame (301) containing target data (303) corresponding to the noun-phrase. This cropped or segmented image data is the “target” of the query, and may be described herein as the target data (303).

There are multiple ways this could be done. One way is to process the textual query to identify the portion which describes the target (referred to herein as the “noun-phrase”) (405), and then search the video stream (130) (i.e., captured image data) for a match and select that matching data (407). For example, if the inquiry is “Who is the guy in the blue suit?”, the noun-phrase “guy in the blue suit” may be found (405) and used to search (407) the image data for a match.

Noun-phrase extraction (405) may be performed using NLP techniques, such as, but not necessarily limited to, rulesets, grammars, heuristics, stemming, statistical analysis and/or inference, artificial intelligence, machining learning, and/or deep learning. Although some or all of the request data may be provided to the noun-phrase extraction (405) module, generally only the transcribed text is needed, though other data could be used, as described elsewhere herein.

In an embodiment, target selection (407) may include categorizing whether the request is a “whole entity” request; that is, where the target of the query is not necessarily a sub-portion of the video stream (130), and so target selection (407) must be performed using data other than, or in addition to the video steam (130). This occurs where the nature of the query requires reference to the audiovisual content as a whole work, regardless of the portion of the video stream (130) being displayed at the time (e.g., “What movie is this?”; “Who directed this?”). This categorization may be done using NLP and other such techniques.

In this particular example, that process may be to identify the audiovisual work (such as by consulting available metadata (134) or examining the content of the video (130) or audio stream (132) and attempting to identify the work using matching algorithms), and then consult a database (136) for additional metadata (134) about the work (e.g., the name of the director). A still further option is to examine the streams (130) and (132) for a textual indication of the director, such as searching for credit sequences at the beginning or end of the work.

More typically, queries may refer to a discrete object in the video stream (130) that will be identified to answer the query (e.g., “Which actor is that?”). A query may contain an indirect question that requires, as a prerequisite, an intermediate answer to a second question before the first question may be answered. This intermediate answer may itself be a direct sub-question, and thus the decoding process (401) may be carried out, at least in part, independently for the sub-question. That is, there may be a partial or full second decoding process (401) carried out with respect to the intermediate question/answer as part of the first decoding process (401) for the user's actual query.

For queries that involve target selection (407) of on-screen content, the target (303) the user is asking about may be selected (407) using any one or more of a number of different methods. Chiefly, machine learning systems, such as a neural network, may be trained to locate matching image data within the video stream (130) based on the extracted noun-phrases or whole query. In an embodiment, linear selection is used. In such an embodiment, the target (303) may be identified based on a predefined rule. The “predefined rule” may be based on the time at which the query took place. For example, if the user asks “Who is this player?” using a linear selection time rule, a VUI (106) might determine that the user intends to find the identity of the player (303) shown in the video stream (130) at the time when the user began speaking the query.

In another embodiment, nonlinear selection is used. In such an embodiment, the query target (303) may be selected using other methods. One such alternative method is ranking of importance. In such an embodiment, a variety of factors may be considered to decide which object or event depicted is the most important, and thus has the highest probability of being the element about which the user seeks more information. Rankings of importance may be context-specific. Again, these techniques may use machine learning and training, such as via a neural network.

By way of example and not limitation, suppose during a baseball game, a player hits a homerun and the camera pans across the crowd reaction. While the crowd reaction is on-screen, the user asks, “Who hit that?” Using ranking of importance, the VUI (106) may determine, through an analysis of the video stream (130), that the most important event was the hitting of the homerun and the user is asking about the batter, not a random member of the audience or even the pitcher. However, if the question was phrased differently (“Who gave up that hit?”), the textual analysis of the query may lead to a different ranking of importance, resulting in a selection of the pitcher as the query target, based on the nature of the question asked. Thus, even though the query was asked while the crowd was on-screen, the VUI (106) may determine through an analysis of the video and/or audio stream around the time of the question (e.g., immediately before) that a different image was the intended target of the inquiry. This is also an example of an instance where a clip, rather than just the still image, is included in the request data.

In another embodiment, directed selection is used. In one such embodiment, directed selection comprises a query specific enough on its terms to unambiguously select (407) the query target within the video stream (130). By way of example and not limitation, if the user is watching a news broadcast showing multiple speakers and the user asks, “Who is on the right?”, the query is specific enough for the VUI (106) to select (407) the target based on the language of the query. In this example, the VUI (106) would select (407) the rightmost person on-screen as the target to be decoded. Again, image recognition techniques may be used, generally in conjunction with a data dictionary (e.g., a neutral network trained on the noun-phrase type as described elsewhere herein) to find the target (303) in the video stream (130).

In an embodiment, noun-phrase selection (405) and target selection (407) may be performed together. This may include providing the entire text of the request to the target selection (407) module. A properly configured and trained machine learning system (e.g., neural network) is capable of consistently and accurately finding both the noun-phrase and matching target data in the video stream (130) even if the noun-phrase is not extracted in advance. For example, using the text “Who is the guy in the blue suit?” for target selection (407) will consistently produce a similar result as using the text “guy in the blue suit.” The image data for that target (e.g., target data) (303), may be used to identify the specific person in the subject identification (411).

Other types of query are possible and may be used in various embodiments. For example, a query may concern audio only (e.g., “What song is this?”) to identify a musical work playing in the background, or “Who sings this?” to identify the performer. The query, “What song is this?” can be answered with reference to the audio stream (132) during a particular moment of the work, and the query “Who wrote this?” is asking about a target which may not be present in the audio stream (132), though identifying the song as a whole is done first.

The target (303) of the query may not necessarily be a person. By way of a non-limiting example, if a user were to ask, while viewing an audiovisual work in which an actor is wearing an attractive item of apparel, “Where can I buy that dress?” the noun-phrase may be “dress” and the target (303) “dress” may be found in the video stream (130). Again, image recognition may be used, such as a neural network trained with apparel data, to identify target data (303) in the video stream (130) indicating objects that match the target type “dress.” The target data for the dress (303) may then be used to identify (411) the specific dress, and other data (136) may be used to find locations where it is offered for sale, and so forth.

In the depicted embodiment, subject identification (411) includes attempting to determine a specific identity of the subject represented by the target data (303). The input to the subject identification (411) module is generally some or all of the request data as well as the target data (303) output from target selection (407). The output of subject identification (411) may be a textual description of the identified subject. This may in turn use context data, and may also involve further image processing and analysis to pinpoint an identity. Other techniques may also be used, some of which are further described herein. For example, other non-target data (i.e., other elements of the frame (301)) within the video stream (130), audio stream (132), metadata (134) or other context may be used to identify the target (303).

In an embodiment, this may be done by reverse-image searching. Again, machine learning systems, such as trained neural network, may be used for this process. Generally, a plurality of subject-type-specific machine learning databases (136) are developed in advance. These databases (136) could be further broken down into a plurality of sub-databases, which may improve accuracy of results. For example, there may be one trained network for people. Alternatively, there may be a plurality of independent trained networks (136) for specific types of people, such as actors or political figures. Still further, there could be sub-networks trained on specific types of training data, such as paintings or portraits of historical figures vs. photographs.

These techniques are not limited to persons, and other databases (136) may be trained to identify other types of discrete objects, such as, but not limited to, locations, buildings, vehicles, products, apparel, venues, animals, trees, and so forth. The methods described herein have practical applications in other industries, such as science and research. As will be clear to a person of ordinary skill in the art, the method (401) could be used by a biologist reviewing a microscope slide, who could ask, “What is that?” and have a system trained on microorganisms search the appropriate data dictionary for a match and identify the particular microorganism in the slide.

Although a single neural network (136) could be used for all search results, it is generally faster, more efficient, and more accurate to provide the target data (303) to a neural network trained on the specific type of data. As such, a subject categorization (409) module may be used to first assign a general category of subject matter to the target data (303). This is generally a broad category (e.g., person, building, venue, clothing, etc.) which can then be used to select which neural network (136) to use in subject identification (411). The subject categorization (409) module generally receives the target data (303) as input and outputs a category, which is essentially a scalar lookup value received by the subject identification (411) module to select the appropriate neural network (136) for the identification search.

In the depicted embodiment, the output of subject identification (411) is a textual representation of the identified subject. This may then be provided as input to a response (413) step or module, along with the noun-phrase from the noun-phrase extraction (405). The response (413) module then provides, or causes to be provided, the answer to the user. Responses may be provided directly as a voice response or, as needed, may be passed along as a translated or converted question to another voice response system. Additionally or alternatively, a non-voice response output may be used, such as a slide-in or pop-up secondary window containing a textual and/or visual representation of the response.

Query responses (413) may be provided by visual, audio, or other means (e.g., a text message or e-mail), and may be provided on the display itself or via a second screen, such as a mobile device or tablet. In an embodiment, the answer is provided visually via an overlay over the displayed content. Additionally, the target data (303) may be highlighted or identified on-screen to help the user know what is being identified. After a response has been given, users may be further provided the opportunity to navigate to supplemental information or media related to the response. If the question is a direct question, the VUI (106) may provide a response containing the identity. If the question is an indirect question, the VUI (106) may then use the identity to determine a result.

The response need not be an answer, but rather could be a confirmation that an action has taken place. For example, an aspect of the present disclosure is that products and services can be purchased or shopped for based upon the video stream. For example, “Buy me that shirt,” could cause a shirt on the screen to be identified, an on-line retailer identified, and pre-connected financial or payment account information for the user used to place an order. The response might simply be the cost and estimated delivery date.

In an embodiment, the response (413) may involve rephrasing to assemble, essentially, a script that is provided to a text-to-speech module to answer the question. For example, if the question is, “Who is the guy in the blue suit”, the noun-phrase is extracted as “guy in the blue suit” and the answer is, “Will Smith.” This step may reassemble these text parts as, “The guy in the blue suit is Will Smith.”

In an embodiment, the response could be provided by a third party VUI, such as Siri™ Alexa™, Cortana™, or Google™. That is, the systems and methods described herein can be used as a layer between a third party VUI to provide the decoding steps described herein, and a new, decoded query can be produced which is specific enough that the third party VUI can answer the question independently. For example, the question, “Who is the quarterback?” may be decoded as “Who is the starting quarterback for the Green Bay Packers,” and that decoded query may be provided to a third party VUI to find and return the answer.

Alternatively, the decoding and response techniques may be implemented in a single, standalone platform, product or service which provides these functions and does not necessarily rely on a third party VUI.

The following non-limiting examples illustrate these and other aspects of the systems and methods described herein.

### Example 1

A user watching a baseball game asks, “Who is the pitcher?” “Pitcher” is extracted as the noun-phrase (405), and select target (407) finds data in the video stream (130) indicative of a pitcher. That target data (303) may then be further analyzed to identify (411) the specific individual. If the player's face is visible in the target data (303), facial recognition may be used. Alternatively, the player's number or name on the jersey, team colors, or even body structure may be examined. If the context of the video stream (130) is available, the VUI (106) can consult that data to narrow the field or pinpoint an identity. For example, if the context indicates that the video stream (130) is a baseball game between the Chicago Cubs and the St. Louis Cardinals, the field of candidate matches may be narrowed to players on the current roster of those two teams. Alternatively, if the team and jersey number can be identified in the video stream (130), it can be compared to roster data to identify the target (303).

### Example 2

Similar techniques can be used with other context data to improve speed and accuracy. For example, if the user is watching a television program and asks, “Who is that?” about an actress on screen, the target data (303) for the actress is found (407), the television show is identified using metadata (134), and the cast list is consulted via a data source (136). Facial recognition algorithms can be used to compare the target data (303) to images of the actresses on the cast list to find a best match. Thus, multiple techniques and data sources, and/or multiple disambiguation techniques, may be utilized to answer any given query.

### Example 3

For certain queries, decoding may involve, effectively, a recursive invocation of itself. For example, consider a viewer watching an audiovisual work depicting two performers, each wearing a dress, and the viewer asks, “Who makes the dress Meryl Streep is wearing?” First, Meryl Streep must be identified (411) in the video stream (130), which involves target selection (407) to identify the humans in the image, subject identification (411) to determine which one (if any) is Meryl Streep, then target selection (407) to find the dress (303) worn by Meryl Streep, then subject identification (411) occurs again to identify the specific dress and access data sources (136) to identify the designer (or pass the query to another VUI). In addition to multiple invocations of the decoding (401) process, this example combines data in the video stream (130) at a moment in time (a specific actor and dress), as well as data not available in the stream about an entity as a whole (e.g., the identity of the designer of the previously identified dress). A wide range of questions can be answered using various combinations of these decoding techniques (e.g., “What car is that?”, “Where was this filmed?”, “What season is this from?”, “Is that a real restaurant?”, “How much is that bottle of wine?”, “How old is the third guy from the left?”).

### Example 4

These techniques may also be combined to answer a wide range of questions taking into account the apparent spatial relationship among various sub-elements in a visual or audit stream (130) and (132), the appearance of each of those sub-elements, and using matching and reverse-lookup algorithms to resolve queries. These techniques allow queries spoken in natural language using three-dimensional terms or descriptions to be used to identify sub-elements in a two-dimensional image. For example, if the query asks, “Who is the second guy to the left behind Harrison Ford?”, the spatial relationship is not a simple left-to-right, but also involves questions of front-to-back ordering. All humans shown in the video stream (130) are located and arranged from left to right, the apparent gender of each is determined, and then the second male from the left is selected (407). The target data (303) is then used to find his identity (411). However, unlike in video game technology, where multiple dimensions and layers are established in the video game data and rendered according to layering rules, a two-dimensional audiovisual stream is “flattened” and third dimensional aspects must be inferred from the spoken query and the data available in the video stream (130). This may be done by identifying a set of candidate matches in the video stream (130) using appearance and relative position, and creating a score identifying which element has the highest confidence level in matching the noun-phrase.

### Example 5

Another aspect is the use of non-identifying or indirectly identifying characteristics to identify a query target, thereby providing additional context identification. This will be understood as different from ordinary image recognition, which uses facial recognition or image matching to determine an identity. Here, the use of non-identifying characteristics involves extracting contextual clues about the potential identity of an inquiry subject in the video stream (130) by examining elements that narrow or refine the scope of potential candidates, and thus increase the confidence level of a match.

By way of example and not limitation, athletes in sports competitions often wear numbered jerseys, but the jersey number itself is reused by various players over the course of a particular sports team's life. Thus, if an inquiry subject is an athlete depicted in the video stream (130), and the athlete cannot be confidently identified by facial recognition (e.g., a football player wearing a helmet), but the jersey number is identifiable, the jersey number may be used to narrow the list of candidates to those players for the team in question who have worn that jersey number. Other data may further refine this technique, or even conclude the identification entirely. For example, if metadata (134) is available indicating the date of the game and the teams participating, the player who wore the particular jersey number for the particular team on that date is generally known. Thus, it is possible that no facial recognition is needed to identify the player. Other context clues may be used to provide limitations or filters to refine the target resolution. By way of example and not limitation, such clues may include the presence or absence of buildings in an image, or the model year of vehicles depicted in an image. It will be noted that these clues may make use of elements of the video stream (130) which are not part of the query target, but which nevertheless can be used to assist in identifying the query target as context.

### Example 6

Other context clues may be used indirectly. The video stream (130) may contain image data for advertisements present in a venue or stadium at the time of the event. Those materials may provide clues as to what year the event took place, or may narrow the scope. For example, given an undated video stream, if an iPhone™ advertisement is identified, it can be inferred that the event took place in 2007 or later. The number and type of context clues may vary, and clue processes may be applied on a case-by-case basis or in accordance to a common set of rules or criteria. Where a given type of video stream (130) has commonly present elements, a ruleset may be used to search for those elements.

### Example 7

This is particularly applicable to sports and athletics, where the video stream (130) generally contains, on a consistent basis, an overlay showing the current state of the competition at that time (e.g., score, time remaining on the game clock, etc.). Sports broadcasts tend to use the same graphical overlays, intros, outros, musical themes, and broadcast style throughout a season. By training a VUI (106) to recognize those elements, the year or season of a given broadcast could be inferred. Also, the overlays themselves can be used to identify a particular sporting event. This in turn allows a play-by-play database (136) to be consulted to answer questions about a particular play. Additionally, or alternatively, video stream (130) can be analyzed to provide information that may not be available in a play-by-play database.

### Example 8

These various techniques can be mixed and matched as needed to identify the target. For example, if a user is watching a film and asks about a background actor who cannot be identified due to the actor being out of focus, the foreground actors may identifiable and used to cross-reference with a cast list for the film to narrow the range of possible matches for the background actor and arrive at the correct answer, or, at a minimum, a higher-confidence guess. This technique may be used to provide limitations or filters to refine or reduce the pool of potential candidate matches. Thus, this technique uses the target selection (407) to find foreground actors, uses subject identification (411) of the foreground actors to identify the film, using other context data by consulting a cast list (136) to identify all actors, and then uses target selection (407) to find background actors (303), and subject identification (411) in combination with the context data to determine the highest-probability match to other actors on the cast list.

### Example 9

An aspect of facial recognition matching technologies is that they are generally reliable when using high-quality images taken at direct angles. However, if an image to be matched is lower quality, angled, or captures a person while at a different age, the confidence of the match may be much lower when the pool of potential matches is very large. However, if the pool of potential matches can be refined, a relative match strength may be considered dispositive. Thus, this aspect may filter potential candidates based on a finite list of elements known to contain the correct match. Programmatically, this technique may lower the confidence threshold to find a match, supplement the confidence rate with a boost factor (e.g., adding a scalar value), or the like. There may also be cases where the finite list of elements is expected to contain the correct match but does not (e.g., such as a cast list omitting an actor due to oversight, an uncredited role, or a pseudonym).

### Example 10

It will be appreciated that the aspect of using context clues may be used in addition or alternatively to refining using external data sources (136). That is, the context clue aspect uses the video stream (130) itself to provide context to filter the field of potential candidates to match, whereas the use of external data (e.g., a cast list) (136) does not rely on context clues in the video stream (130) itself. Each technique may be used depending on the nature of the difficulty or challenge in decoding an inquiry target. For example, where the image recognition is accurate and results in a high-confidence image recognition that nevertheless fails to identify an individual due to insufficient data (e.g., the system has high confidence that it has correctly identified a helmeted football player, the player's team jersey, and the player's number, but cannot perform facial recognition at all due to the helmet, or has correctly identified a baseball pitcher who has his back to the camera), context clues may be more helpful. However, where the image recognition cannot be completed with high confidence (e.g., due to a poor quality image, bad angle, or algorithmic failure), external sources may be used. It will be understood that either or both may be used in an embodiment.

### Example 11

Although this description is generally made with respect to a smart television (103), these techniques apply in other contexts as well, such as when using a smart phone (140). In such cases, additional context data may be available, and may be used for context identification, which in turn may be used for subject identification. For example, location, orientation and/or directional information may be used, such as, without limitation, in providing additional context cues to filter visual matches.

By way of example and not limitation, in an embodiment, a mobile device (140) or augmented reality wearable computer may be used to capture optical or visual data about the physical surroundings of a user. The user may provide a query related to the optical data, and the video stream (130) received by the mobile device (140) or wearable device may be subjected to decoding as described herein. For example, if the user is wearing augmented reality headwear (e.g., an eyepiece) or holding up a smart phone (140), and asks, “How much do these apartments cost?”, the available location, orientation, or directional data for the device (140) may be used to identify the buildings in question. For example, the locational data may be used to narrow the user's geographical location to a small range. Alternatively, or additionally, orientation or directional data for the device (140) may be used to narrow the set of buildings the user may be referring to in the query.

### Example 12

A viewer is watching the 1977 movie Star Wars on a smart television (103) or display having a VUI (106). The user speaks the question, “Who directed this movie?” The VUI (106) transcribes to text, and the text is then parsed and analyzed to determine what is being asked. For example, the parts of speech may be categorized to identify that the user is asking “who” and thus is seeking the identity of a person, that the person sought is a “director” of a film, and that the film in question has been ambiguously identified as “this movie” (e.g., the noun-phrase). This query thus requires entity disambiguation, and then reference to either metadata (which may or may not list the director) or a database.

Depending on how the content is being received by the display, metadata may be available to disambiguate the inquiry. A digital broadcast will include the title of the film in the metadata about the stream, which can be consulted to disambiguate “this movie.” Alternatively, the movie may be played from physical media, such as a disc, in which case the disc may have the title of the film. In another alternative, the video stream (130) could be accessed to capture a still image, which could be analyzed to identify the film. In a still further alternative, the currently tuned channel could be determined, and a scheduling service could be consulted to determine what film is currently being broadcast on that channel.

### Example 13

A user is watching a sports broadcast and asks, “Who's at quarterback?” Because the inquiry is not about the video stream as an entity, but rather about an object in the frame, further analysis is needed to disambiguate the query and answer the question. For example, the visual feed may be examined to determine which team is currently on offense. The data about the broadcast may indicate which team is home and which is away, a database of team colors for home/away games may be consulted, and the jersey color of the team currently in an offensive formation can be identified, and then the current roster for that team can be examined to identify the quarterback. Alternatively, the location of the game could be consulted to identify the home team and the same general process used. In a still further embodiment, the number on the jersey of the player in the quarterback position may be identified in the image data and used to look up in a database the name of the player wearing that number for that team. As will be clear, once the player is disambiguated, other inquiries can be answered using similar techniques and answering specific questions about the player using external data sources (e.g., “How much does he make?” “How tall is he?” “How many kids does he have?” “Where did he play in college?”).

### Example 14

While watching a St. Louis Cardinals baseball game, a user may ask, “How much was this stadium?” The decoding process could then determine, as already described, that the game being watched is in St. Louis, Mo., identify Busch Stadium as the venue, and then decode the query as, “How much did it cost to build Busch Stadium in St. Louis, Mo.?” Again, this decoded query could be either passed to a third party VUI or answered directly.

### Example 15

The announcers during a sports broadcast remark that “Peyton Manning's wife gave birth to a boy yesterday.” The user could ask, “What did they name him?” and the software can determine the context of the ambiguous pronouns “they” and “him” to mean “the Mannings” and “their new baby,” respectively. Thus, the decoded query becomes, “What did Peyton and Ashley Manning name their youngest son?”

### Example 16

These techniques may be used to provide program guide-type information or real-time statistical data. By way of another non-limiting example, suppose the user is watching a St. Louis Cardinals game. Cardinals player Yadier Molina is up to bat and hits a homerun. The user asks, “How many homeruns has he hit this season?” “He” is decoded to “Yadier Molina” and a roster and statistical data are used to find Molina's statistics for the season.

### Example 17

The user is watching a news broadcast and a panel of four experts is shown discussing a topic. The user does not recognize one of the panelists, and issues the query, “Who is that on the right?” The panelists can be visually identified in the video stream, their positions relative to each other in the image data can be determined, and facial recognition techniques used in combination to identify the person on the right.

### Example 18

A user is watching a replay of Super Bowl XXXI, and the user asks, “Who has the ball?” while player 26 is shown returning a kick off. The face of player 26 is not visible, but metadata for the broadcast can identify that the event is Super Bowl XXXI, the teams were Green Bay and New England, and the season was 1996. Image recognition can determine that the player in question is wearing a Green Bay uniform, historical roster data may be consulted to determine that Desmond Howard wore #26 for Green Bay in 1996, and thus the inquiry subject is Desmond Howard.

### Example 19

A user is watching an episode of The Fresh Prince of Bel-Air and asks, “How old is he now?” while actor Will Smith is on the screen. The frame in question may show Smith at a younger age, in a low-definition picture, and at an angle. The confidence in the match of that particular frame of Smith may be too low to produce a usable result when the pool of candidates is all potential candidate actors. However, if it is known that the person depicted must be one of a few dozen people on the cast list for that episode, it is likely that the correctly matching cast will have a much higher match percentage than the others, and that relatively high confidence may be used to determine that this is the correct match. In another embodiment, the image may be compared to contemporary images of the cast. For example, if the episode in question aired in 1992, known images of each actor circa 1992 may be used to perform the match, and may produce a higher confidence. In another embodiment, “aging” technology may be used to artificially age the image of the inquiry subject to the present (e.g., by calculating the 2019−1992=27 years, and aging the frame by 27 years) and matching to modern data images.

### Example 20

A user is watching a Chicago Bulls vs. New York Knicks game, and a long three-point shot is made. The user may ask, “How far was that shot?” The game overlay can be examined to find the score, period, and time remaining, identify the game based on that status at that time, and then consult a play-by-play database to see who took the immediately prior shot and from how far. If the distance information is not available, it can be estimated from the image. For example, an NBA basketball court is 94 feet in length. Thus, if the frame shows a player taking a shot, it can be determined that the player's position is 25% of the distance between the baseline and the half court line, and simple mathematics can be used to calculate the shot distance from the rim.

### Example 21

The techniques described here can be used to reverse search for a particular sports event irrespective of the image on a screen. For example, a user could ask, “Who hit the game-winning shot in the 2016 March Madness finals?” or “Show me Kurt Warner's last throw in the NFL.” This may also be used to provide a general search engine for sports plays. For example, “Search for game-winning shots by Michael Jordan.” These same techniques can also be used to ask questions about the current state of a game that is not currently being shown, or about prior events. For example, the user may ask, “How many timeouts do they have left?” or “How many fouls does LeBron have?” or “Who committed that penalty?”

### Example 22

Multiple camera angles may be resolved as part of disambiguation to segment the video stream (130) to correspond to narrative descriptions that match natural language searching. In a baseball game, for example, “right field” may be depicted from multiple camera angles. Deep learning algorithms can be trained on the video stream (130) to recognize the area that is “right field” regardless of the camera angle. This information can then be used to select (407) query targets (e.g., “Who is in right field?”). Additionally, and/or alternatively, these techniques can be used in decoding to resolve a query, whether or not the user provides that description. For example, if the user is watching the right fielder catch a fly ball and asks, “Who is that?”, the image can be examined, the area can be resolved to “right field”, and then game roster data (136) can be checked to see who is playing right field.

The functionality is described herein with respect to discrete steps, but as is clear from the examples and description, image processing is often involved and several steps may be carried out simultaneously, out of the described order, or may be repeated. It should also be noted that the systems and methods described herein may be implemented as a single logical software and/or hardware unit, or distributed among a plurality of different physical devices, depending on the design goals and engineering needs of any given implementation.

For example, it is specifically contemplated that a prior art smart television could be paired with a mobile phone having an application implementing these systems and methods, and the query can be provided to by the user via the mobile application, which then receives access to the video stream, provides the query and live image data to a remote sever for decoding, and the phone provides the response. Alternatively, a smart television could be manufactured specifically to implement these elements without the need for an external mobile phone, or in conjunction with a specialized controller or remote. Still further, the decoding services could be device-neutral or device-independent, and simply offered via a server implementation as an on-line service offering, and VCDs can independently implement use of it via an application programming interface or software development kit.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A non-transitory computer-readable medium having computer-readable program instructions embodied thereon, said instructions comprising:
a request acquisition module receiving an audibly spoken question including a noun-phrase and a video stream, said request acquisition module converting said audibly spoken question to text and capturing a image data of a still frame of said video stream associated with a point in time of said video stream when said audibly spoken question is received;
a noun-phrase extraction module receiving said text and extracting therefrom said noun-phrase;
a target selection module identifying target data in said image data, said target data corresponding to said extracted noun-phrase;
a subject identification module generating a textual description of the identity of a target represented in said target data; and
a response module generating a script comprising said noun-phrase and said textual description of said identity.

2. The medium of claim 1, wherein said audibly spoken question is converted to text by a speech recognition module.

3. The medium of claim 1, wherein said request acquisition module further includes program instructions for acquiring metadata about said video stream.

4. The medium of claim 1, wherein said target selection module identifies said target data using a machine learning system.

5. The medium of claim 4, wherein said machine learning system comprises a neutral network.

6. The medium of claim 1, wherein said subject identification module generates said textual representation using a machine learning system.

7. The medium of claim 6, wherein said machine learning system comprises a plurality of neural networks, each neural network in said plurality being trained on a target category.

8. The medium of claim 7, further comprising:
a target categorization module assigning a category to said target data; and
said subject identification module generating said textual description using a selected neural network from said plurality of neural network, said selected neural network being determined based on said assigned category.

9. The medium of claim 1, wherein said medium is included in a display device.

10. The medium of claim 9, wherein said display device is a smart television.

11. The medium of claim 1, wherein said medium is included in a mobile device.

12. The medium of claim 1, wherein said video stream is received via a telecommunications network.

13. The medium of claim 1, wherein said response module causes to be vocalized a response to said audibly spoken question, said vocalized response based at least in part on said script.

14. The medium of claim 13, wherein said vocalization is performed using a voice user interface.

15. The medium of claim 14, wherein said voice user interface comprises a digital assistant.

16. The medium of claim 1, wherein said target data represents a subject selected from the group consisting of: a human; an animal; a vehicle; an article of clothing; a venue; a geographic feature; a structure; a building; and, a consumer product.

17. A computerized method for answering an ambiguous user query comprising:
receiving a video stream and displaying said video stream;
receiving an audibly spoken question at a first time during said display of said video stream;
converting said audibly spoken question to text;
capturing image data of said video stream at said first time;
extracting a noun-phrase from said converted text;
identifying in said image data target data corresponding to said noun-phrase;
generating a textual description of said target data;
generating a script comprising said noun-phrase and said textual description; and
vocalizing said script.

18. The method of claim 17, further comprising:
assigning a category to said target data; and
in said generating a textual description, generating said textual description using a neural network trained using image data corresponding to said category.

19. A method for gesture-based control of a display device comprising:
providing a display device comprising a computer vision system and a microphone array;
said microphone array locating an origin of a spoken wake-word;
said computer vision system identifying a first human at said origin;
forming a user profile for said identified first human, said user profile including facial recognition data for said identified first human;
said computer vision system recognizing at least one control gesture performed by said identified first human, said at least one control gesture corresponding to a ruleset for operating said display device; and
operating said display device in accordance with said recognized at least one control gesture.

20. The method of claim 19, further comprising:
storing said user profile in a computer-readable storage medium;
repeating said locating, said identifying, said forming, said recognizing, and said operating steps for a second human;
after said microphone array locating a second origin of a spoken wake-word and said computer vision system identifying said first human at said second origin, retrieving said user profile for said first human.
